(19) United States
(12) Patent Application Publication
(10) Pub. No.: US 2003/0201556 A1
(43) Pub. Date: Oct. 30, 2003

(54) Method of controlling a molding system

(76) Inventors: William Lloyd Ramsey, Winters, CA (US); Gerald Jay Bellasalma, Yorba Linda, CA (US)

Correspondence Address: CARLSON, GASKEY & OLDS, P.C., 400 WEST MAPLE ROAD, SUITE 350, BIRMINGHAM, MI, 48009, US

(21) Appl. No.: 10/136,717

(22) Filed: Apr. 30, 2002

(51) Int. Cl. B29C 45/77

(52) U.S. Cl. 264/40.3

(57) ABSTRACT

A method of controlling a molding system for fabricating a molded article from a settable mixture includes the steps of priming several discharge containers with different components of the settable mixture and evacuating the discharge containers through a conduit into a mixing head. The mixing head combines the components to form the settable mixture that is then injected into the mold. During the priming step, pressure within each of the discharge containers is monitored to detect air being drawn into the system. Pressure of the settable mixture is monitored at the mixing head and at the mold tool to detect any blockages that can cause damaging pressure fluctuations. To prevent built up of residual settable mixture within the settable mixture, all parts of the system that contact the settable mixture are flushed with a solvent and then air-dried to rid the system of the solvent.

### BACKGROUND OF THE INVENTION

This invention relates to a method of controlling a molding system for fabricating a molded article from a settable mixture.

Many methods of fabricating molded articles include the mixing of at least two fluid materials to form a settable mixture that is discharged into a mold tool. The fluid materials typically include at least two reactive components that harden when mixed. Typically, the settable mixture is injected into the mold tool at a high pressure such that little residual settable mixture remains within the conduits to the mold tool. However, in a low pressure molding system where the settable mixture is not injected at high pressures, a greater amount of settable mixture may remain in the conduits to the mold tool. Residual settable mixture will harden over time and may cause undesirable blockages within the conduits to the mold tool. Such blockages may result in higher pressure within the molding system. The higher pressure can cause damage to the molding system if not properly monitored and diagnosed.

Accordingly, it is desirable to develop a method of controlling a molding system that can expel residual settable mixture to prevent blockages, and sense pressure build ups to prevent damage to the molding system.

### SUMMARY OF THE INVENTION

An embodiment of this invention discloses a method of controlling a low pressure molding system to prevent residual build up and detect pressure fluctuations within the molding system.

The molding system includes a mold tool supported by a structure, a material delivery system, and material storage containers. Components stored within the material storage containers combine to form a settable mixture that is injected into a cavity of the mold tool to form a molded article. The material delivery system includes at least one discharge container for each component. Each discharge container includes a piston connected by a shaft to a plenum. A drive cylinder drives the plenum vertically. A position sensor is disposed on the plenum to monitor the relative position of the plenum during operation of the material delivery system. Each of the discharge containers is in communication with a material storage container, and the mixing head. An inlet valve and an outlet valve are disposed at each discharge container to control flow of components into and out of each discharge container. Components from the material discharge containers are directed through a conduit to the mixing head. Each of the components travels through a separate conduit to metering valves disposed within the mixing head. The metering valves control the flow of components into the mixing head to maintain a predetermined ratio required to form the settable mixture.

The mixing head includes an air inlet valve and a solvent inlet valve to control flow of air and solvent used to flush and dry the conduit of the molding system exposed to the settable mixture. Settable mixture that hardens within the mixing head or the conduit to the mold tool may partially block the passage to cause increased pressure with the molding system. Dramatic increases in pressure may cause damage to the molding system, and it is therefore desirable to take precautions to prevent such a blockage. A mold valve is disposed at the mold tool to control the flow of settable mixture into the mold tool. Further, the mold valve includes a setting to vent air pressure supplied to the mix head.

Pressure of the components and the settable mixture are monitored to safeguard the molding system from undesirable pressure fluctuations. As such, various pressure sensors are disposed throughout the molding system to monitor pressure at different stages of the molding process.

A first step in the method of molding includes the step of priming each of the discharge containers. The plenum raises upward to move the pistons upward, thereby drawing a specific quantity of component into each discharge container. As the plenum rises, a pressure sensor monitors the pressure inside each of the containers such that the controller may compare the pressure within the discharge containers with a prime pressure value. Deviation from the prime pressure value indicates that air is being drawn into the discharge container. If air is being drawn into the discharge cylinder the molding cycle will be shut down to prevent damage to the system.

The next step of the method is the injection step and includes actuation of an injection timer. The injection timer sequentially initiates operation of the inlet and outlet valves, the mixing head and the mold valve at specified time values. A first time value signals actuation of the inlet and outlet valves to close the inlet valves and open the outlet valves. A second time value signals actuation of the motor of the mixing head. A third time value signals actuation of the metering valves of the mixing head and starts the plenum downward to expel the components into the mixing head.

The plenum moves downwardly until reaching a predetermined empty position as indicated by the position sensor. Pressure within the mixing head, the conduit and the mold cavity is monitored to detect pressure fluctuations indicative of a blockage. Pressure detected above a predetermined threshold will cause a controller to shut down the molding system until corrective action can be taken to prevent damage to the molding system.

During any mold cycle, a quantity of settable mixture remains within the mixing head, the conduit and the mold valve and must be removed before hardening and forming a blockage. A flush cycle includes flowing solvent through the mixing head through to the mold valve and out of the molding system. The flow of solvent is for a predetermined time calculated to fully rid the molding system of residual settable mixture in preparation for the next molding cycle. The solvent is evacuated by a blast of pressurized air introducing into the mixing head.

The method of this invention prevents damage to a low pressure molding system by monitoring pressure fluctuations and by flushing residual settable mixture from the system after every molding cycle to prevent damage.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of the molding system;

FIG. 2 is a schematic view of the material delivery system; and

FIG. 3 a flow chart illustrating the method steps of this invention.

### DETAILED DESCRIPTION OF THE PREFERRED EMBODIMENT

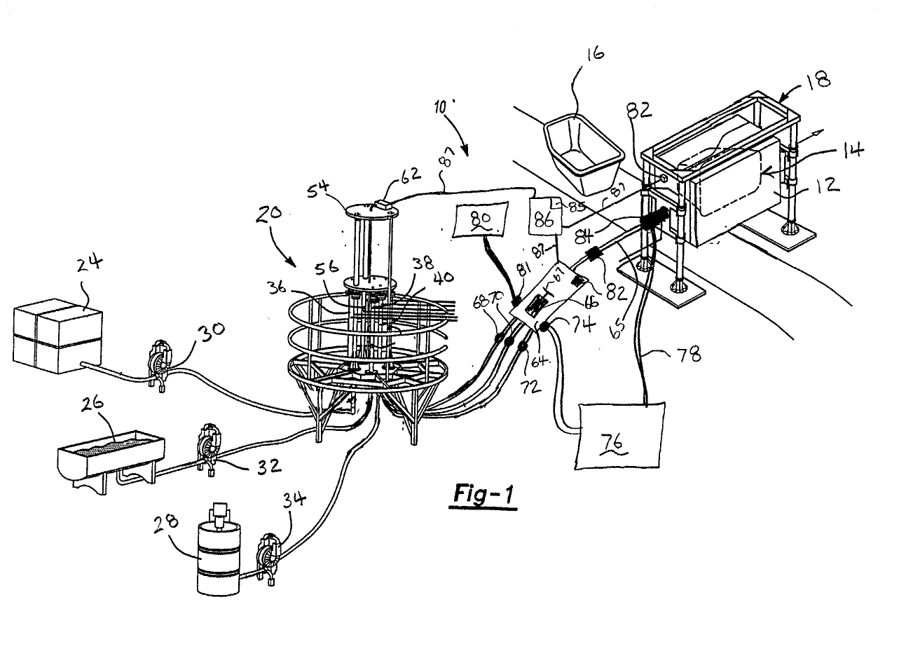

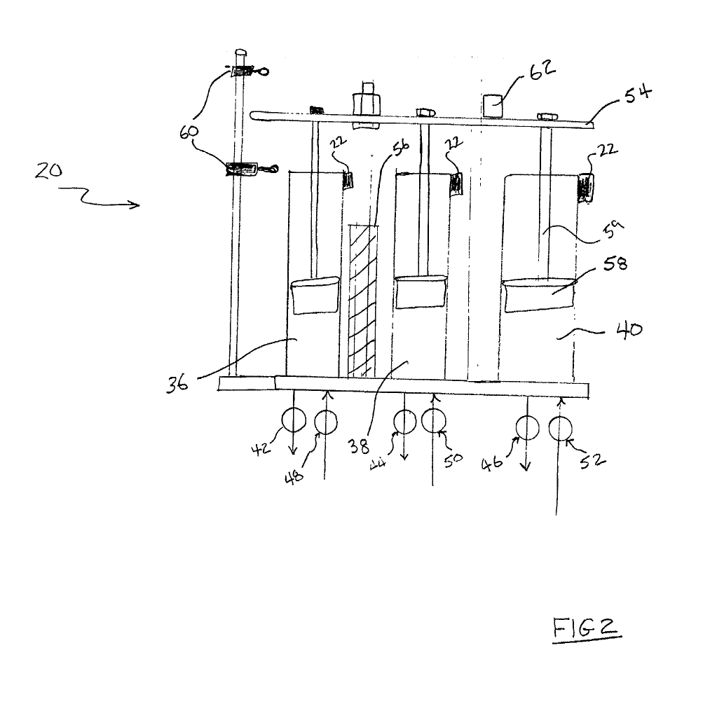

Referring to FIGS. 1 and 2, a disclosed embodiment of this invention is a method of controlling a molding system 10 including a mold tool 12 supported by a structure 18. The molding system 10 includes a material delivery system 20 in communication with material storage containers 24, 26, and 28, a mixing head 64 in communication with the material delivery system 20 and a controller 86. Components stored with the material storage containers 24, 26, and 28 combine to form a settable mixture that is injected into a cavity 14 of the mold tool 12 to form a molded article 16. The molded article illustrated is a bath tub, however it is within the contemplation of this invention to fabricate any type of molded article with this method.

The material delivery system 20 includes at least one discharge container for each component. Preferably, the delivery system includes three discharge containers 36,38, and 40, each of which draws a component of the settable mixture from each one of the material storage containers 24, 26, and 28. Each discharge container 36, 38 and 40, includes a piston 58 connected by a shaft 59 to a plenum 54, best shown in FIG. 2. The plenum 54 is driven vertically by a drive cylinder 56. The drive cylinder 56 is preferably a hydraulically actuated cylinder controlled to drive the plenum 54 upward and downward, thereby driving the attached pistons 58 upward and downward. Although a hydraulic cylinder is illustrated in the preferred embodiment, it is within the contemplation of this invention to use any type of drive as known by one skilled in the art.

A position sensor 62 is disposed on the plenum 54 to monitor the relative position of the plenum 54 during operation of the material delivery system 20. The position sensor 62 may be of any type known to one skilled in the art. The position sensor 62 is in communication with the controller 86 such that the controller 86 controls movement of the plenum 54 by way of the drive cylinder 56. Further, proximity sensors 60 are positioned to sense when the plenum 54 has reached extreme limits of horizontal travel. The proximity sensors 60 are also in communication with the controller 86.

The controller 86 is in communication with the material deliver system 20, the mixing head 64 and the mold tool 12 to control and monitor the entire molding process. Lines 87 schematically illustrate the communication between the controller 86, the material delivery system 20, the mixing head 64 and the mold tool 12.

Each of the discharge containers 36,38 and 40 is in communication with a material storage container 24, 26, and 28 and the mixing head 64. Preferably, flexible hoses communicate components with each of the discharge containers 36,38 and 40. An inlet valve 48,50 and 52 and an outlet valve 42, 44, and 46 are disposed at each discharge container 36,38 and 40 to control flow of components into and out of each discharge container 36,38 and 40. Each of the valves 42-52 actuate in response to signals from a controller 86. The inlet and outlet valves 42-52 along with the controller 86 are of any type as known to one skilled in the art.

Components from the discharge containers 36,38, and 40 are directed through a conduit to the mixing head 64. Each of the components travels through a separate conduit to the mixing head 64. As should be appreciated, each of the conduits may be a flexible hose, pipe, or any other type of conduit known to one skilled in the art for transporting a fluid medium. Metering valve 68,70, and 72 control the quantity of component that flows into the mixing head 64 to maintain a predetermined relationship between each of the components such that the components are properly combined to form the settable mixture.

The mixing head 64 includes a mixing device 67 driven by a motor 66. The specific configuration of the mixing head 64 is best described in pending application Ser. No. 09/662,662 titled “Mix Head Assembly for a Molding Material Delivery System” herein incorporated by reference. Although preferably, the mixing head 64 is as disclosed in the described pending application, a worker knowledgeable in the art will understand that the method of this invention can be applied with mixing heads of differing configurations.

The mixing head 64 includes an air inlet valve 81 and a solvent inlet valve 74 to control flow of air and solvent used to flush and dry components of the molding system 10 exposed to the settable mixture. As appreciated, once the components of the settable mixture are combined, a curing process is initiated that acts to harden the settable mixture to form the molded article 16. Residual settable mixture remaining within the mixing head 64 along with the conduit 65 from the mixing head 64 to the mold tool 12 may also harden. Settable mixture that hardens within the mixing head 64 or the conduit to the mold tool 12 may block the passage to cause increased pressure with the molding system 10. Dramatic increases in pressure may cause damage to the molding system 10, and it is therefore desirable to take precautions to prevent such a blockage.

The settable mixture evacuated from the mixing head 64 travels through the conduit 65 to a mold valve 84. The mold valve 84 is disposed at the mold tool 12 to control the flow of settable mixture into the mold tool 12 such that settable mixture does not escape from inside the cavity 14 of the mold tool 12, and also to control the amount of settable mixture injected into the mold cavity 14. The mold valve 84 further includes an outlet leading back to a solvent supply 76. The mold valve 84 includes a setting within which settable mixture is allowed into the mold cavity 14, another setting closes off flow to the mold cavity 14, and another setting allowing the flow of solvent out of the conduit 65. Further, the mold valve 84 includes a setting to vent air pressure supplied to the mix head 64. Air pressure from an air supply 80 is introduced into the mixing head 64 and conduit to dry and expel any remaining solvent to prevent contamination of the settable mixture during molding operations.

Pressure of the components and the settable mixture are monitored to safeguard the molding system 10 from undesirable pressure fluctuations. Various pressure sensor are disposed throughout the molding system 10 to monitor pressure at different stages of the molding process. The material delivery system 20 includes pressure sensors 22 to measure pressure within each of the discharge containers 36,38, and 40 as component is drawn from the material supply containers 24, 26 and 28. The mixing head 64, the conduit 65 and the mold tool 12 include pressure sensors 82 to monitor pressure during injection of the settable mixture into the mold tool 12.

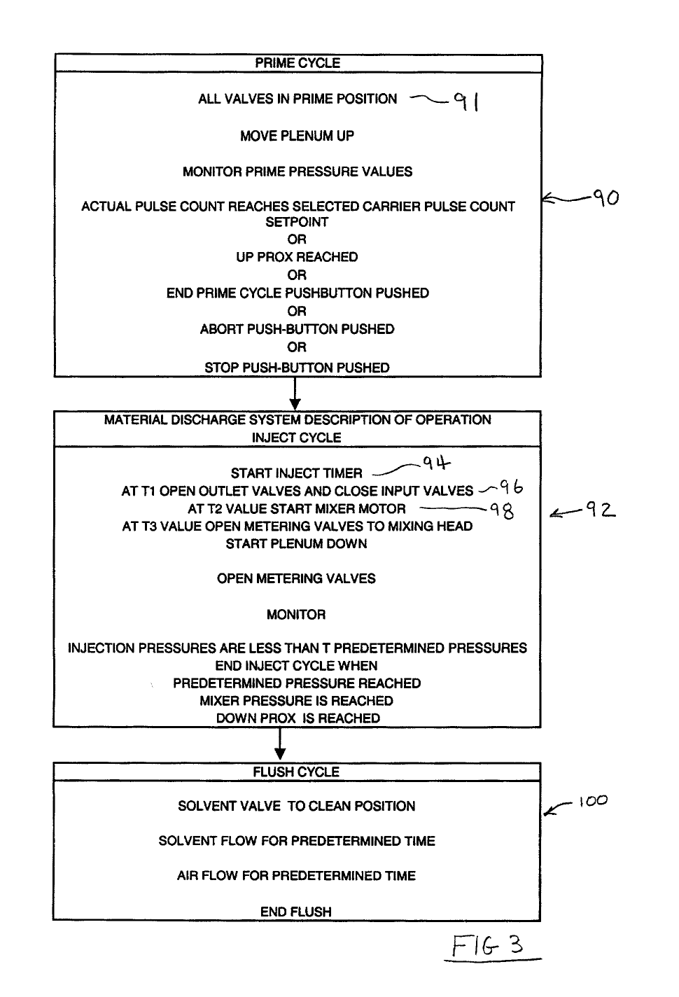

Referring to FIG. 3, a flow chart of a process according to the present invention includes the first step of priming each of the discharge containers 36, 38, and 40 as indicated at 90. The priming step 90 includes the sub steps of opening each of the inlet valves 48,50,52 and closing each of the outlet valves 42,44, and 46. This configuration of the inlet and outlet valves is the prime position indicated at 91.

The plenum 54 is then raised upward to draw the pistons 58 upward, thereby drawing a specific quantity of component into each discharge container 36, 38, and 40 40. Note that each discharge container 36, 38 and 40 is of a predetermined size such that the size relationship between each of the discharge containers 36,38 and 40 provides the ratio of components required to form the settable mixture. Further, although three discharge containers are shown in this embodiment, it is within the contemplation of this invention that several discharge containers may contain the same component to provide the correct ratio to form the settable mixture.

As the plenum 54 raises, the pressure sensors 22 monitors the pressure inside each of the containers such that the controller 86 may compare the pressure within the discharge containers 36,38, and 40 with a prime pressure value. The prime pressure value is a value that represents optimal filling of the discharge containers 36,38, and 40. Deviation from the prime pressure value indicates that air is being sucked into the discharge container 36,38, and 40, and will cause a stoppage of the molding system 10. As appreciated, air above a predetermined pressure within one of the discharge containers 36,38, and 40 disrupts the proper mixing of components, and may also cause undesirable pressure fluctuations within the molding system 10.

The plenum 54 is raised until reaching a filled position as indicated by the position sensor 62. Further, if the top limit proximity sensor 60 is tripped this will also cause the plenum 54 to stop. Once the plenum 54 has reached the filled position, each of the discharge containers 36, 38 and 40 contain the predetermined amount of component. The molding system then moves to the injection step as indicated at 92.

The controller 86 initiates the beginning of an injection timer 85. The injection timer 85 is used to sequentially initiate operation of the inlet and outlet valves 42-52, the mixing head 64 and the mold valve 84. These times include a start delay to allow the inlet and outlet valves to shift to a injection position and to allow the motor 66 of the mixing head 64 to reach a predetermined level of operation.

A first time value, T1 (indicated at 94) signals actuation of the inlet and outlet valves 42-52 to close the inlet valves 48-52 and open the outlet valves 42-46. A second time value, T2 (indicated at 96), signals actuation of the motor 66 of the mixing head 64. A third time value, T3 (indicated at 98), signals actuation of the metering valves 68,70, and 72 of the mixing head 64. The plenum 54 starts downward to expel each of the components to the mixing head 64. During movement of the plenum 54 and flow of component material to the mixing head 64, the metering valves 68, 70 and 72 open proportionally to balance incoming flow of component material to ensure that the relationship is correct to form the settable mixture.

The specific ratio of component material used to form the settable mixture is provided for by the sizing of the discharge containers 36,38, and 40 in relation to each other. The metering valves 68, 70 and 72 provide a second means of providing the proper quantity of component material to form the settable mixture. As should be appreciated, as the component materials are flowing to the mixing head 64, instances may occur where the proper ratio of component material is improper to form the settable mixture. The metering valves 68,70 and 72 control the flow of component material such that all times during he combination and mixing a proper ratio of component material is present within the mixing head 64.

The plenum 54 moves downwardly until reaching a predetermined empty position as indicated by the position sensor 62. The lower proximity switch 60 will signal the controller 86 to stop downward movement if the plenum 54 does not stop in response to signals from the position sensor 62.

During the injection cycle, components are mixed to form the settable mixture by the mixing head 64 and further injected through the conduit 65 and mold valve 84 into the mold cavity 14. Pressure within the mixing head 64, the conduit 65 and the mold cavity 14 is monitored to detect pressure fluctuations that would indicate a blockage. As discussed above, a blockage in the conduit 65 may cause damage to the molding system 10. For that reason, a pressure detected above a predetermined threshold will cause the controller 86 to shut down the molding system 10.

During a normal molding cycle settable mixture is injected into the mold cavity 14 and the mold valve 84 closed. A quantity of component material will remain in the conduit 65 between the mixing head 64 and the material delivery system 20. The component material in these conduits is not mixed and therefore does not immediately harden and can remain within each of the conduits until the next molding cycle. Settable mixture remains within the mixing head 64, the conduit 65 and the mold valve 84 and must be removed before hardening to prevent a blockage.

The flush cycle (indicated at 100) proceeds by closing the mold valve 84 to isolate the mold cavity 14 and allow flow of solvent. The mixer head 64 solvent valve 74 is opened and solvent flows through the mixing head 64, the conduit 65, and the mold valve 84 to evacuate any residual settable mixture. The flow of solvent is for a predetermined time calculated to fully rid the molding system 10 of residual settable mixture in preparation for the next molding cycle. After the solvent has flowed for a predetermined time, the solvent itself must also be evacuated from the mixing head 64, the conduit 65 and the mold valve 85, because the solvent may contaminate the settable mixture during subsequent molding cycles. For this reason, pressurized air is introduced into the mixing head 64 to drive out any remaining solvent from the mixing head 64, the conduit 65 and the mold valve 84. Again air is flowed from the mixing head to the mold valve 84 for a predetermine amount of time calculated to remove all remnants of solvent in preparation for the next molding cycle.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason, the following claims should be studied to determine the true scope and content of this invention.

What is claimed is:

1. A method of controlling a molding system for fabricating a molded article from a settable mixture, said method comprising the steps of:
a. priming a plurality of discharge containers with a component of the settable mixture;
b. setting at least one valve of the discharge containers to a discharge position in response to a first time value;
c. actuating a mixer motor within a mixing head at a second time value greater than the first time value;
d. evacuating the discharge containers through a conduit into the mixing head at a third time value greater than the second time value;
e. mixing the components of the settable mixture within the mixing head;
f. injecting the settable mixture into a mold.

2. The method of claim 1, further comprising the step of flushing the mixing head and a conduit to the mold tool to evacuate residual settable mixture with a solvent.

3. The method of claim 2, further comprising flowing solvent through the mix head, the conduit, the mold valve, a predetermined time.

4. The method of claim 2, further comprising the step of communicating pressurized through the mixing head and the conduit to evacuate the solvent.

5. The method of claim 4, further comprising communicating pressurized air through the mixing head, the conduit and a mold valve for a predetermined time

6. The method of claim 1, further comprising sensing a prime pressure within each of the discharge containers;
comparing the sensed prime pressure with a prime pressure cutout value; and
discontinuing said step (a) in response to a sensed prime pressure differing from said prime pressure cutout value by a predetermined amount.

7. The method of claim 6, further comprising measuring the pressure within the mold.

8. The method of claim 6, further comprising measuring the pressure within the mixing head.

9. The method of claim 6, further comprising measuring the pressure within the conduit between the mixing head and the mold.

10. The method of claim 1, wherein said molding system further comprises a mold valve to control flow of settable mixture from the mixing head into the mold, said method further comprising actuating the mold valve prior to said step f.

11. The method of claim 1, further comprising sensing a pressure of said settable mixture; and
performing said step f. until a predetermined pressure is achieved.

12. The method of claim 1, further comprising the step of initiating actuating of a timer in response to completion of said step a.

13. The method of claim 1, further comprising indicating completion of said step a. in response to attaining a predetermined pulse count set point.

14. The method of claim 1, further comprising indicating completion of said step a in response to actuating a proximity switch.
